(19) United States
(12) Patent Application Publication
(10) Pub. No.: US 2021/0218266 A1
(43) Pub. Date: Jul. 15, 2021

(54) SMART CHARGE AND POWER SUPPLY DEVICE FOR MOBILE VEHICLES

(71) Applicant: CHIN-SHIH OU, Taipei City (TW)

(72) Inventor: CHIN-SHIH OU, Taipei City (TW)

(21) Appl. No.: 16/738,400

(22) Filed: Jan. 9, 2020

(51) Int. Cl. H02J 7/14; H02J 1/10; H02J 7/00

(52) U.S. Cl. CPC H02J 7/14; H02J 7/007; H02J 1/10

(57) ABSTRACT

A smart charge and power supply device for mobile vehicles comprises a transmission, a power generator having a free wheel and connected to the transmission, a first battery, a second battery, a first switching mechanism connected between the transmission and the first and the second batteries, and a second switching mechanism connected between the power generator and the first and the second batteries. The transmission is provided for driving a transmission mechanism of an electric mobile vehicle. The free wheel is driven by the transmission and has smooth rotational movements to improve the efficiency of the power generator in generating power to charge the batteries. The first and the second switching mechanisms are provided for switching one of the first and the second batteries supply power and charging the other for driving the mobile vehicle and having the power generator to charge a weak battery.

### BACKGROUND OF THE INVENTION

### 1. Field of the Invention

This invention relates to a smart charge and power supply device for mobile vehicles, and particularly to a smart charge and power supply device for mobile vehicles which provides increased efficiency by extending the run time of power supply.

### 2. Description of Related Art

In face of the global worsening air pollution problem, governments all over the world have been actively encouraging industries to develop electric mobile vehicles (e.g. electric boats, electric buses, or electric transporting vehicles) for replacing air-polluting vehicles with combustion engines, which are driven by petrochemical fuel, to achieve the purpose of saving energy and reducing carbon emissions. As electric mobile vehicles are powered by rechargeable batteries, charging facilities such as charging stations are of vital importance for providing battery recharge. Actually, at the moment batteries of electric mobile vehicles may be recharged only in charging stations.

When a battery of a conventional electric mobile vehicles has run out of power, the battery protection circuit will cut off power supply straightaway, causing the moving electric mobile vehicles to come to an abrupt stop and get out of control due to instant power failure. Therefore, when a battery is running out of power and the nearest battery swapping station is too far away, the driver may feel panic or an accident may be caused. Further, when an electric mobile vehicle may no longer move due to power failure, the driver will need to resort to a cart or a crane truck for help, which is a waste of time and money. Therefore, the technology of extending the run time of power supply is essential for the popularization of electric mobile vehicles. In view of this, after laborious research and experiments, the applicant has devised a smart charge and power supply device for mobile vehicles which provides increased efficiency by extending the run time of power supply.

### SUMMARY OF THE INVENTION

It is a main objective of this invention to provide a smart charge and power supply device for mobile vehicles which provides increased efficiency by extending the run time of power supply through the operation of having a first battery and a second battery alternate between supplying power and being charged.

A foregoing smart charge and power supply device for mobile vehicles comprises a transmission, a power generator having a free wheel and connected to the transmission, a first battery, a second battery, a first switching mechanism connected between the transmission and the first and the second batteries, and a second switching mechanism connected between the power generator and the first and the second batteries. The transmission is provided for driving a transmission mechanism of an electric mobile vehicle. The free wheel is driven by the transmission, and with its characteristic of storing rotational energy the free wheel has a reduced fluctuation of rotational speed and therefore has smooth rotational movements, which may improve the efficiency of the power generator in generating power to charge the batteries. The first and the second switching mechanisms are provided for switching between having one of the first and the second batteries supply power and charging the other, having a fully-charged battery provide power to the transmission for driving the mobile vehicle and having the power generator charge a weak battery. With the foregoing operation of having the first and the second batteries alternate between supplying power and being charged, this invention may achieve the objective of extending the run time of power supply and increasing the efficiency of electric mobile vehicles.

A foregoing smart charge and power supply device for mobile vehicles, wherein the transmission is pivotally connected to a transmission mechanism of a mobile vehicle with a transmission shaft and the free wheel is pivotally connected to the transmission shaft with a support shaft.

A foregoing smart charge and power supply device for mobile vehicles, wherein the first battery, the second battery, the first switching mechanism, and the second switching mechanism are separately connected to a control circuit, which detects the capacity of the first battery and the second battery and controls the switching operation of the first switching mechanism and the second switching mechanism according to the detected capacity.

### BRIEF DESCRIPTION OF THE DRAWINGS

FIG. 1 is a three-dimensional view of the invention;

FIG. 2 and FIG. 3 are structural drawings of the invention;

FIG. 4 is a view of the invention in operation;

FIG. 5 is another view of the invention in operation.

### DETAILED DESCRIPTION OF THE PREFERRED EMBODIMENTS

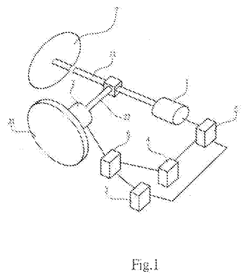

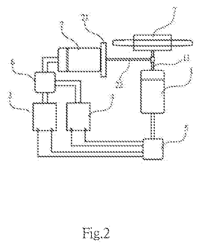

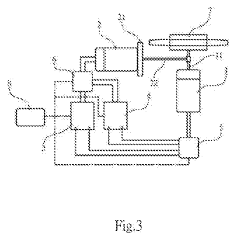

Please refer to FIG. 1 and FIGS. 2 to 3, illustrating respectively a three-dimensional view and structural drawings of the invention. As the figures show, the invention comprises a transmission 1, a power generator 2 having a free wheel 21, a first battery 3, a second battery 4, a first switching mechanism 5, and a second switching mechanism 6, wherein the transmission 1 is pivotally connected to a transmission mechanism 7 of a mobile vehicle with a transmission shaft 11 for driving the transmission mechanism 7 to make the mobile vehicle move.

The power generator 2 is pivotally connected to the transmission shaft 11 with a support shaft 22 so that the pivotally connected free wheel 21 is driven by the transmission 1. With its characteristic of storing rotational energy, the free wheel then drives the power generator 2 to generate power.

The first battery 3 and the second battery 4 are separately connected to the first switching mechanism 5 and the second switching mechanism 6, connecting to the transmission 1 through the first switching mechanism 5 and to the power generator 2 through the switching mechanism 6.

The first battery 3, the second battery 4, the first switching mechanism 5, and the second switching mechanism 6 are separately connected to a control circuit 8, which detects the capacity of the first battery 3 and the second battery 4 and controls the switching operation of the first switching mechanism 5 and the second switching mechanism 6 according to the detected capacity so that the first battery 3 and the second battery 4 may alternate between supplying power and being charged.

The foregoing components are combined to form a smart charge and power supply device for mobile vehicles. The transmission 1 is provided for driving the transmission mechanism 7 of an electric mobile vehicle through the transmission shaft 11 to make the mobile vehicle move. The free wheel 21 is driven through the support shaft 21. With its characteristic of storing rotational energy the free wheel 21 has a reduced fluctuation of rotational speed and therefore has smooth rotational movements, which may improve the efficiency of the power generator 2 in generating power to charge the first battery 3 or the second battery 4. The first switching mechanism 5 and the second switching mechanism 6 are provided for switching between having one of the first battery 3 and the second battery 4 supply power and charging the other, having a fully-charged battery provide power to the transmission 1 for driving the mobile vehicle and having the power generator 2 charge a weak battery. With the foregoing operation of having the first battery 3 and the second battery 4 alternate between supplying power and being charged, this invention may achieve the objective of extending the run time of power supply and increasing the efficiency of electric mobile vehicles.

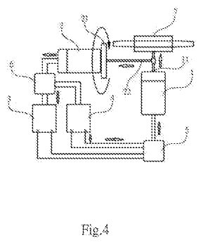

Please refer to FIG. 4, illustrating a view of the invention in operation. As the figure shows, when the invention is in operation, the transmission 1 drives the transmission mechanism 7 of an electric mobile vehicle through the transmission shaft 11 to make the mobile vehicle move, and meanwhile through the support shaft 21 the transmission 1 drives the free wheel 21, whose characteristic of storing rotational energy improves the efficiency of the power generator 2 in generating power. In the present embodiment, the second battery 4 is providing power to the transmission 1, while the first battery 3 is being charged by the power generator 2. The control circuit 8 constantly detects the capacity of the first battery 3 and the second battery 4. When the capacity of the second battery 4 is down to a low point, the control circuit 8 drives the first switching mechanism 5 and the second switching mechanism 6 to have the first battery 3 switched to provide power to the transmission 1, and at the same time have the second battery 4 switched to be charged by the power generator 2. With the foregoing operation of having the first battery 3 and the second battery 4 alternate between supplying power and being charged, this invention may achieve the objective of extending the run time of power supply and increase the efficiency of electric mobile vehicles.

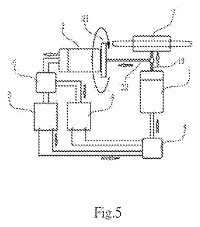

Please refer to FIG. 5, illustrating another view of the invention in operation. As the figure shows, when the first battery 3 is providing power to the transmission 1, the second battery 4 is being charged by the power generator 2. The control circuit 8 constantly detects the capacity of the first battery 3 and the second battery 4. When the capacity of the first battery 3 is down to a low point, the control circuit 8 drives the first switching mechanism 5 and the second switching mechanism 6 to have the second battery 4 switched to provide power to the transmission 1, and at the same time have the first battery 3 switched to be charged by the power generator 2. With the foregoing operation of having the first battery 3 and the second battery 4 alternate between supplying power and being charged, this invention may achieve the objective of extending the run time of power supply and increasing the efficiency of electric mobile vehicles.

The foregoing preferred embodiments of this invention are illustrated of this invention rather than limiting of this invention. It is intended to cover various modifications and changes included within the spirit and scope of the appended claims, the scope of which should be accorded the broadest interpretation so as to encompass all such modifications and similar structures.

In view of the foregoing, this invention is a smart charge and power supply device for mobile vehicles including a power generator having a free wheel, a first battery, a second battery, a first switching mechanism, and a second switching mechanism. By having the first battery and the second battery alternate between supplying power and being charged, this invention may achieve the objective of extending the run time of power supply and increasing the efficiency of electric mobile vehicles.

What is claimed is:

1. A smart charge and power supply device for mobile vehicles, comprising:
a transmission for driving a transmission mechanism to make an electric mobile vehicle move;
a power generator having a free wheel, wherein the free wheel is driven by the transmission and with its characteristic of storing rotational energy the free wheel has a reduced fluctuation of rotational speed and therefore has smooth rotational movements, which may improve the efficiency of the power generator in generating power to charge batteries;
a first battery and a second battery separately connected to a first switching mechanism and a second switching mechanism, connecting to the transmission through the first switching mechanism and to the power generator through the switching mechanism for switching between having one of the batteries supply power and charging the other, having a fully-charged battery provide power to the transmission for driving the mobile vehicle and having the power generator charge a weak battery; with the foregoing operation of having the first and the second batteries alternate between supplying power and being charged, the objective is achieved of extending the run time of power supply and increasing the efficiency of electric mobile vehicles.

2. A smart charge and power supply device for mobile vehicles of claim 1, wherein the transmission is pivotally connected to a transmission mechanism of a mobile vehicle with a transmission shaft to make the mobile vehicle move.

3. A smart charge and power supply device for mobile vehicles of claim 1, wherein the free wheel is pivotally connected to the transmission shaft so that the free wheel is driven by the transmission.

4. A smart charge and power supply device for mobile vehicles of claim 1, wherein the first battery, the second battery, the first switching mechanism, and the second switching mechanism are separately connected to a control circuit, which detects the capacity of the first battery and the second battery and controls the switching operation of the first switching mechanism and the second switching mechanism according to the detected capacity.
